(19) United States
(12) Patent Application Publication
(10) Pub. No.: US 2017/0098271 A1
(43) Pub. Date: Apr. 6, 2017

(54) Systems and Methods for Remote Robotic Apparel Fitting and Shopping

(71) Applicant: Shidong Chen, Irvine, CA (US)

(72) Inventor: Shidong Chen, Irvine, CA (US)

(21) Appl. No.: 15/284,723

(22) Filed: Oct. 4, 2016

Related U.S. Application Data
(60) Provisional application No. 62/237,548, filed on Oct. 5, 2015.

(51) Int. Cl. G06Q 30/06

(52) U.S. Cl. CPC G06Q 30/0643; H04L 67/02

(57) ABSTRACT

Remote apparel fitting has long remained a problem technically and commercially since the start of online e-commerce. Various virtual fitting rooms have been disclosed in prior inventions and tried, where simulated apparel fitting results are generated from computer models. As a contrast, the present invention discloses systems and methods for remote robotic apparel fitting, shopping and showing, where the apparel fitting results are produced by a real piece of apparel worn by a body matched robotic fitting apparatus, and the apparel fitting results are captured and watched by a shopper through one's personal remote vision provided by a remote vision apparatus.

This application refers to the prior provisional application under application No. U.S./62/237,548 filed on Oct. 5, 2015.

### BACKGROUND OF THE INVENTION

Field of Invention

The present invention relates to remote apparel fitting, remote apparel shopping and showing, and generally relates to remote retail shopping, remote robotic avatar visiting and participating.

Background

In modern economies, as the production of goods grows year after year, the consumption needs to grow proportionally too. Retail shopping is the key activity that transfers the goods from the production into the consumption.

Traditionally, retail shopping is conducted by visiting “brick and mortar” stores. Typically, an apparel shopper, assumed a female human as an example in the follow description, goes to a “brick and mortar” apparel store. She browses the real pieces of apparel in a shopping room with her own vision, looks into all the details determined by her personal shopping need and preference and searches for the pieces of apparel that interest her. Commonly, when the target person she shops for is herself, she goes to a fitting room to wear interested pieces of apparel by herself and watch the fitting results typically in a mirror to determine: a) if the styles of interested pieces of apparel suit her well and, b) which sizes of interested pieces fit her well. This fitting method is referred as in-person fitting, and this fitting room is referred as in-person fitting room. This conventional “brick and mortar” shopping store is referred as conventional in-person shopping store. The prior invention disclosed an apparatus to enhance the traditional mirror based in-person fitting room [1]. In-person fitting is real, true and accurate. However, it is not always possible. For example, in-person fitting is not available when the target person she shops for is not herself but a family member or friend, and the target person is not with her.

Nowadays, as internet-based e-commerce thrives, more and more shoppers go shopping in online stores. The online e-commerce shopping provides the preferred shopping convenience. Recorded videos are widely used by online e-commerce websites. Internet-based live video broadcasting of sales event with text or phone interaction with the event host is disclosed in prior invention too [2]. However, it is unable for an online shopper to browse the real merchandise with her own vision, look into all details and watch fitting results according to her personal shopping need and preference.

Due to the importance of apparel fitting in apparel retail shopping, various virtual fitting methods and virtual fitting rooms have been disclosed in prior inventions [3][4] and tried by online apparel retailers. In general, virtual fitting methods and virtual fitting rooms require a computer fitting model of human body for each target person and a computer fitting model of each piece of apparel, and then generate the computer display of simulated fitting results of a specific piece of apparel worn by a specific target person. Given the wide span of apparel styles and details contributed by elasticity, textile, color, pattern, decoration, thickness, transparency, softness, weight, etc., it remains a big technical challenge to build a computer fitting model for each piece of apparel with enough accuracy in representing the real piece to make the virtual fitting accurate enough to be true. Further, it remains a big commercial problem that an online retailer has to afford a considerable or even prohibitive running cost to build such a computer fitting model for every piece of apparel ever to be sold.

It is the objective of the present invention to address the remote apparel fitting and shopping problem.

### SUMMARY OF THE INVENTION

The present invention presents systems and methods for remote robotic apparel fitting, shopping and showing, where the apparel fitting results are produced by a real piece of apparel worn by a body matched robotic fitting apparatus (referred as RFA), and the apparel fitting results are captured and watched by a shopper through one's personal remote vision provided by a remote vision apparatus (referred as RVA).

In a reality room, i.e. “brick and mortar” room, the systems of the present invention include one or multiple RFAs; one or multiple RVAs. Outside the room, the systems of the present invention further includes shopper devices at remote end; and network units in-between. The shopper devices include but are not limited to shopper-operated smart phones, tablet computers, personal computers and wearable computing devices. The network units includes internet and local area networks. As an aspect of the present invention, all RFAs and RVAs are connected with shopper devices via network units and can be remotely controlled by shoppers to conduct remote apparel fitting and shopping. This apparel fitting method is called the robotic apparel fitting. It is different from either the traditional in-person fitting or the existing online virtual fitting. This room is called a robotic apparel fitting, shopping and showing room (referred as the room) or a robotic apparel shopping store. It is different from either the conventional in-person shopping stores or the e-commerce online stores.

An RFA includes a robotic apparatus, which receives externally inputted body measurement via electronic methods, optical methods, acoustic methods etc., adjusts its own body type and size to fully or partially match the given body measurement under certain constraints, and within certain range of accuracy, produces the remote fitting results of the real pieces of apparel worn by the body matched RFA. In an embodiment of the present invention, each RFA is set up by human staff to wear one or multiple pieces of apparel to be sold. Upon a shopper's request, it receives the body measurement sent by the shopper via internet, adjusts by itself its own body type and size, matches the received body measurement under certain constraints, and within certain range of accuracy, produces the remote fitting results of the real piece or pieces of apparel worn by the body matched RFA. The body measurement includes but is not limited to the data obtained by the manual measurement of human body and the 3-dimensional human body scan. Depending on the requirement of fitting of a certain piece of apparel, an RFA may match the body measurement of a full human body or only a part of human body.

In one embodiment of the present invention, an RFA includes a body surface pressure measuring apparatus, which measures and collects the values of pressure on different areas of the surface of the body of the AFA (referred as body surface pressure). The measured values of the body surface pressure are sent to the shopper as additional fitting results.

In one embodiment, the RFA further includes a skin tone changing apparatus, which changes the color of the surface of the body of the RFA under the shopper's instruction to match a given skin tone. In one embodiment, an RFA includes an internal or in-skin color lighting apparatus, which changes the body surface color of the RFA to match a given skin tone by changing the color of its color lighting under shopper's control.

In order to allow a shopper to easily watch the fitting results from various view angles including but not limited to front view, left side view, back view, right side view and top view, in one embodiment of the present invention, an RFA further includes a rotating apparatus, which makes the RFA to rotate along one or multiple axes under shopper's control. In another embodiment, the systems of the present invention further includes display bases, each including a rotating apparatus that makes the display base rotate along one or multiple axes under shopper's control. The RFA is placed on a display base. Under the shopper's control, the display base rotates and turns the above RFA accordingly.

In order to allow a shopper to watch the fitting results under various human body poses including but not limited to the standing, sitting and walking poses, in an advanced embodiment, an RFA further includes a pose changing apparatus, which changes the RFA's pose from one to another under shopper's control. The poses include still poses and moving poses. Still poses include standing pose, sitting pose, lying-down pose, a still pose frozen from a moving pose at certain moment etc. The moving poses include standing-up pose, sitting-down pose, walking-pose etc.

The RVA includes mobile RVAs and fixed RVAs. Each RVA includes a camera subsystem, which includes one or multiple video cameras, captures the live field scene in the room and provides personal remote vision to a shopper so she can see the live field scene in the room remotely via the network units. Especially, the RVA allows the shopper to browse the apparel shown in the room and watch the fitting results produced by an RFA.

In one embodiment of the present invention, a mobile RVA includes a camera subsystem, a modem subsystem, and a moving subsystem, all mounted together to a mechanic housing or frame typically. A shopper remotely controls an RVA to move around in the room, browses the shown apparel and watches the fitting results. In another embodiment, a mobile RVA further includes an obstacle detection system, which detects the shortest line-of-sight non-obstructive distance at certain directions or certain ranges of directions.

In one embodiment of the present invention, a fixed RVA includes a camera subsystem, a modem subsystem, but not a moving subsystem. The fixed RVA does not take shoppers' controls to move around in the room. Usually, fixed RVAs are placed close to and around the RFAs, so a shopper can choose a fixed RVA surrounding the RFA wearing the pieces of apparel she is interested, and remotely browses the shown apparel and further watch the fitting results.

In order to provide additional apparel information for a piece of apparel, including but not limited to apparel description, “where to buy” information and the e-commerce web page information, in one embodiment of the present invention, the system of the present invention further includes ID devices. An ID device is placed close to or inside an RFA or the display base the RFA is placed on. The ID device contains the ID information including but not limited to numbers, text, barcodes and 2-dimensional barcodes. The ID information is used to: a) given an RFA wearing certain piece of apparel, locate the additional apparel information such as e-commerce web page of the piece of apparel, b) given an e-commerce web page of a certain piece of apparel, locate the RFA wearing the piece of apparel, and c) provide other identification-based functions. The ID devices include but are not limited to the visual ID devices and the electronic ID devices. A visual ID device visually shows the ID information on a display board, an electronic display device, or anything else suitable. An electronic ID device, such as RFID, encodes the ID information into an electronic signal. In one embodiment, the visual ID device is read by shopper through her remote vision. In another embodiment, the systems of the present invention further include one or multiple machine vision subsystems, and the visual ID device is analyzed and recognized by a machine vision subsystem. In yet another embodiment, the electronic ID device is read by an electronic reading device including but not limited the modem subsystem of an RVA.

As another aspect of the present invention, the remote apparel fitting results is produced without the requirement of a computer fitting model for any piece of apparel to be sold.

The systems of the present invention are able to provide various services, including but not limited to remote robotic apparel fitting (shoppers are outside the room and are at remote end), local robotic apparel fitting (shopper are inside the room), and remote apparel shopping (shoppers are outside the room and are at remote end), local robotic apparel shopping (shopper are inside the room), remote robotic apparel showing (audience are outside the room), local robotic apparel showing (audience are inside the room) etc.

In general, the RFA is a customer-controllable field-effectuator (i.e. an apparatus that takes actions to an object in the field area upon customer's control) dedicated for apparel shopping. By adopting other types of field-effectuators, the systems of the present invention allow a customer to remotely watch the field area with the customer's remote vision and remotely interact with the objects in the field through the field-effectuators for the objects.

### BRIEF DESCRIPTION OF THE DRAWINGS

FIG. 1 illustrates an embodiment of the systems and methods of the remote robotic apparel fitting, shopping and showing of the present invention.

FIG. 2 illustrates an embodiment of the methods of the remote robotic apparel fitting of the present invention.

FIG. 3 illustrates an embodiment of the methods of the remote robotic apparel shopping of the present invention.

### DETAILED DESCRIPTION OF THE INVENTION

The principle and embodiments of the present invention will now be described in detail with reference to the drawings, which are provided as illustrative examples so as to enable those skilled in the art to practice the invention. Notably, the figures and examples below are not meant to limit the scope of the present invention to a single embodiment but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration

For the purpose of brevity, the original methods and systems of the present invention mentioned above will be described in detail while the derivative methods will not.

In the following description of the present invention, the data, signal or information flow from a device or apparatus to the Internet is called upload, such a connection is called uplink; the data, signal or information flow from Internet to a device or apparatus is called download, such a connection is called downlink.

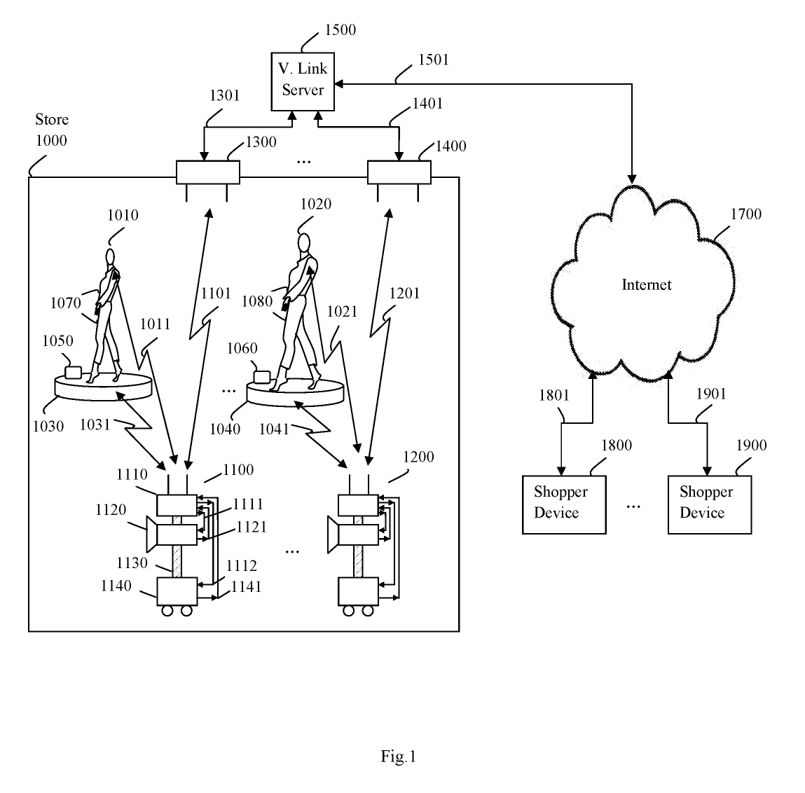

FIG. 1 illustrates an embodiment of the systems and methods of the remote robotic apparel fitting, shopping and showing of the present invention. A remote robotic apparel fitting, shopping and showing room labeled as 1000 is a reality room, i.e. “brick and mortar” room, not a virtual room. In the room 1000, the systems of the present invention include RFAs labeled as 1010 to 1020, display bases labeled as 1030 to 1040, ID devices labeled as 1050 to 1060, RVAs labeled as 1100 to 1200, and wireless base stations labeled as 1300 to 1400. In or local to the room 1000, the systems of the present invention further include a vision link server labeled as 1500. Remote to the room 1000, the systems of the present invention further include shopper devices labeled as 1800 to 1900, and the internet in-between labeled as 1700.

In the embodiment illustrated in FIG. 1, the RVAs adopt mobile RVAs that move around in the room 1000 upon shop's control. The moving subsystems of the mobile RVAs include but are not limited to on-floor moving structure and on-track moving structure. In another embodiment, the RVAs adopt fixed RVAs that are placed around RFAs by human staff. In yet another embodiment, RVAs include both mobile RVAs and fixed RVAs.

In the illustrated embodiment in FIG. 1, the room 1000 is set up by human staff so that the RFA 1010 and 1020 are clothed in piece of apparel labeled as 1070 and 1080 respectively. To allow a shopper to find her best size, the piece of apparel 1070 and 1080 illustrated in FIG. 1 are shown to be of same style but in different sizes. In an embodiment, each RFA has a default fitting mode and a personal fitting mode. In the default fitting mode, an RFA adjusts its own body type and size to match a body measurement set by human staff while in personal fitting mode, it adjusts itself to match a body measurement sent by a remote shopper. In the illustrated embodiment if fig.1, for example, the RFA 1010 is set to a smaller body size in default fitting mode and is clothed in a smaller size of piece of apparel 1070 while the RFA 1020 is set to a bigger body size in default fitting mode and is clothed in a bigger size of piece of apparel 1080.

The RFA 1010 and 1020 are placed on the display base 1030 and 1040 respectively. The visual ID device 1050 and 1060 are placed on the display base 1030 and 1040, close to RFA 1010 and 1020 respectively.

In the embodiment of the present invention illustrated in FIG. 1, an RFA is connected with an RVA wirelessly. The RFA 1010 and 1020 are connected with the RVA 1100 and 1200 via the wireless connection 1011 and 1021 respectively. Similarly, the display base 1030 and 1040 are connected with the RVA 1100 and 1200 via wireless connection 1031 and 1041 respectively. In one embodiment, the wireless connections 1011 to 1021 and 1031 to 1041 adopt short distance wireless connections, including but not limited to Bluetooth connections.

In a preferred embodiment of the present invention, the wireless base stations 1300 to 1400 are mounted on the ceiling of the room 1000. Each RVA is wirelessly connected with at least one wireless base station. The RVA 1100 and 1200 are connected with 1300 and 1400 via wireless connection 1101 and 1201 respectively. In one embodiment, the wireless connections 1101 to 1201 adopt IEEE 802.11 wireless LAN (WLAN) connections. In another embodiment, the wireless connections 1101 to 1201 adopt other non-WLAN connections, such as specific dedicated wireless connections to carry vision videos and data traffic. In yet another embodiment, the wireless connections 1101 to 1201 adopt WLAN to carry data traffic but specific dedicated wireless connections to carry vision videos.

Functionally, a wireless base station in FIG. 1 translates physical signals from a wireless connection on to a wired connection and vise versa, and thus relays the uplink and downlink traffic bi-directionally. Practically, wireless base stations provide the wireless coverage in the room 1000, establish and maintain wireless video links, and especially keep the wireless video links roaming seamlessly when the mobile RVAs move inside the room 1000.

In the embodiment of the present invention illustrated in FIG. 1, in or local to the room 1000, the systems of the present invention further include a vision link server 1500. The wireless base stations 1300 to 1400 are connected to the vision link server 1500 via local wiring 1301 to 1401, and then the vision link server 1500 is connected with internet 1700 via internet access connection 1501.

The basic function of a vision link server is, in the uplink to receives videos of the remote visions from the RVAs, and sends the videos of the remote visions to the shopper devices at remote end via the network units, and in the downlink, to receive the control signals from the said shopper devices at remote end, forwards the control signals to the RVAs, the RFAs and other shopper-controllable apparatuses and devices in the room, such as display bases.

In the embodiment in FIG. 1, the vision link server 1500 streams the live vision videos from the RVAs 1100 to 1200 to shopper devices 1800 to 1900 over internet 1700. In detail, it gathers local uplink traffic from wireless base stations 1300 to 1400 and forwards it onto internet 1700, and meanwhile forwards the downlink traffic from internet 1700 to destined wireless base stations. A practical vision link server 1500 has more functions. In one embodiment of the present invention, the uplink vision videos from the RVAs 1100 to 1200 are uncompressed or lightly compressed. The vision link server 1500 needs to trans-compresses (decompresses and then re-compresses) the uplink vision videos into heavily compressed video streams suitable for internet streaming. In another embodiment, the uplink vision videos from the RVAs 1100 to 1200 are not carried over IP (Internet protocol). The vision link server 1500 needs to convert the uplink videos into streaming videos carried over IP. In yet another embodiment, the vision link server 1500 includes a machine vision subsystem, which analyzes the uplink vision videos, recognizes specific field objects in the vision videos, such as the visual IDs displayed on ID devices, and provides the object-specific information, such as the e-commerce web pages of the identified pieces of apparel to shoppers. In yet another embodiment, the vision link server records the uplink vision videos locally and playbacks local recordings when it is requested. In yet another embodiment, the vision link server 1500 generates additional fitting results (detailed later) and synthesizes the generated fitting results with the remote vision to enhance the remote robotic fitting results.

Remote to the room 1000, the shopper devices 1800 to 1900, are connected to the internet 1700 via their internet access connections labeled as 1801 to 1901 respectively. A shopper device can be a shopper's smart phone, tablet computer, notebook computer, desktop computer, wearable computing device etc.

In the embodiment of the present invention illustrated in FIG. 1, through the above-mentioned wireless and wired connections three end-to-end logic links can be established for each shopper device. For example, a remote vision link is built between the shopper device 1800 and the RVA 1100, a remote fitting link is built between the shopper device 1800 and the RFA 1010, and remote display base link is built between the shopper device 1800 and the display base 1030. This reflects the situation where the shopper in front of the shopper device 1800 is assigned with the RVA 1100, and she is in control of the RFA 1010 and the display base 1030 to conduct the remote robotic fitting of the piece of apparel 1070 worn on the RFA 1010. This situation is used as an example usage case in the following description. It can be clearly seen the embodiment illustrated in FIG. 1 reflects one aspect of the present invention, that is, shoppers are connected with and able to remotely control the RVAs, the RFAs and the display bases in the room 1000.

FIG. 1 also illustrates an embodiment of the mobile RVA of the present invention. The RVA 1100 includes a modem subsystem 1110, a camera subsystem 1120 and a moving subsystem 1140, all mounted together to a mechanic housing or frame 1130. In one embodiment of the present invention, the moving subsystem 1140 adopts a wheel-based moving structure, which provides moving functions for the RVA 1100 to move freely on the floor of the room 1000. The moving functions include moving forward or backward, accelerating or stopping, and turning left or right. In another embodiment of the present invention, the moving subsystem further provides moving function to vertically raise or lower the camera subsystem 1120 along the mounting frame 1130.

The camera subsystem 1120 is capable of capturing the live field scene around the RVA 1100. The camera subsystem 1120 includes one or multiple cameras. In one embodiment of the present invention, the camera subsystem includes at least one pan, tilt, pan-tilt, or pan-tilt-zoom camera (referred as P-camera, T-camera, PT-camera, PTZ-camera), which allows a remote shopper to browse more products and more details with less robotic moves. In another embodiment of the present invention, the camera subsystem includes a camera mounted on the end of a retractable telescope-like pipe. This allows a remote shopper to check the close-up details of a product at a desired view angle. In yet another embodiment of the present invention, the camera subsystem 1120 adopts a stereo camera subsystem. This provides the remote shopper with the three dimensional (3D) remote vision in the room 1000.

A modem subsystem 1110 communicates with other subsystems of the RVA through wired or wireless connections. It also wirelessly communicates with one or multiple wireless base stations. In the downlink of the remote vision link, the modem subsystem 1110 receives the shopper-generated control signals from the wireless base station 1300. It outputs the camera control signal 1111 to the camera subsystem 1120. The camera control signal 1111 is usually used to control the camera settings, including but not limited to the video frame rate, the video resolution, the focus area, the PTZ etc. The modem subsystem 1110 also outputs the moving control signal 1112 to the moving subsystem 1140, where it is used to control the robotic moving on the floor or the vertical moving of the camera subsystem. In the uplink of the remote vision link, the modem subsystem 1110 receives the live videos for field vision and status information signal 1121 from the camera subsystem 1120 and the status information signal 1141 from the moving subsystem 1140 and other systems. Then the modem subsystem 1110 further sends the received vision video and status information to the wireless base stations 1300 via wireless connections 1101.

The modem subsystem 1110 of an RVA also wirelessly communicates with an RFA, a display base and an electronic ID device if there is. Functionally, a modem subsystem 1110 translates physical signals from one wireless connection onto another one and vise versa, and thus relays the uplink and downlink traffic of the remote fitting link and the display base link bi-directionally. In one embodiment, a modem subsystem 1110 translates physical signals from a Bluetooth connection onto an IEEE 802.11 connection and vise versa, and thus relays the uplink and downlink traffic of the remote fitting link and the display base link bi-directionally.

There are various embodiments to implement the systems of the present invention. In one embodiment, the RFAs 1010 to 1020 and the display bases 1030 to 1040 are connected by wired connections to the vision link server 1500, and are further connected with and controlled by shoppers. Therefore, the RVAs 1100 to 1200 do not have wireless connections with either the RFAs 1010 to 1020 or the display bases 1030 to 1040.

In another embodiment, the RVAs 1100 to 1200 do not include on-floor moving subsystems, but on-track moving subsystems. A track system, such as a monorail system is installed in the room 1000. In one embodiment of the present invention, the track system is installed on the floor of the room 1000 and the RVAs move on the track. In another embodiment of the present invention, the track system is installed beneath the ceiling and the RVAs hang “upside down” on to the track. In yet another embodiment of the present invention, the track system is installed in the air and the RVAs either stand on the track or hang “upside down” on to the track. In one embodiment, the RVAs 1100 to 1200 do not adopt wireless connections, but are connected to the vision link server 1500 by local wiring.

In yet another embodiment, the RVAs 1100 to 1200 are fixed RVAs and do not have the moving subsystems 1140, but rather stand on the floor or hang down from ceiling or mount at other fixed positions. In one embodiment, the fixed RVAs do not adopt wireless connections, but are connected to the vision link server 1500 by local wiring.

The systems of the present invention function to provide various services including but not limited to remote robotic apparel fitting, remote apparel shopping, apparel showing, and apparel design guidance.

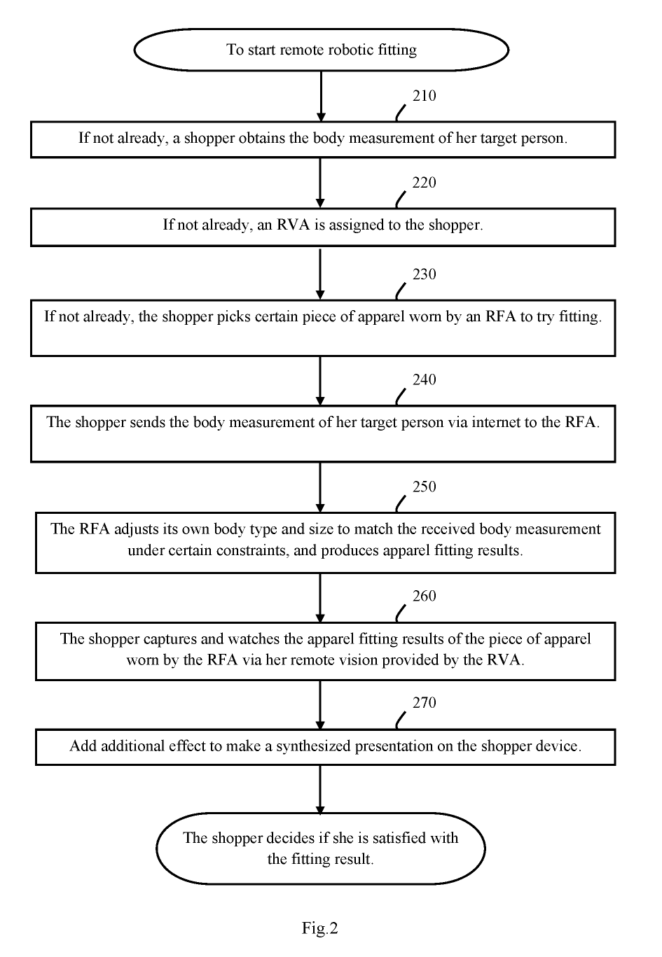

FIG. 2 illustrates an embodiment of the methods of the remote robotic apparel fitting of the present invention, which includes the following steps:

Step 1, labeled as 210. If not already, a shopper obtains the body measurement of her target person. The methods of the present invention require the body measurement to provide personal fitting results as in-person fitting does. Traditionally, the body of the target person is measured manually by the shopper herself or someone else (referred as manual body measurement). Today, various prior inventions disclose apparatuses and methods to scan a human body 3-dimensionally (referred as 3D body scan). Some allow a human body to be scanned by professional equipments and services while some allow a human body to be scanned by herself or a family member. The 3D body scan provides much higher accuracy in the measurement of the body type and size. However, both manual body measurement and 3D body scan are accepted by the methods of the present invention. In one embodiment of the present invention, when a 3D body scan is received, an RFA directly adjusts its own body type and size to match a 3D body scan. When a manual body measurement is received, it is first interpolated into a 3D body scan according to certain rule, and then the RFA adjusts its own body type and size to match the interpolated 3D body scan.

Step 2, labeled as 220. If not already, an RVA is assigned to the shopper. As assumed above, the shopper operating the shopper device 1800 is assigned with the RVA 1100.

Step 3, labeled as 230. If not already, the shopper controls the RVA to browse the room and picks certain piece of apparel worn by an RFA to try fitting. In one embodiment of the present invention, human staff has set up the room 1000 so that the RFAs are set to different body types and sizes in default fitting mode and are clothed in pieces of apparel in different styles and sizes. After the shopper is assigned with an RVA, she obtains her personal remote vision in the room 1000. She browses the shown apparel in the room 1000 and as assumed above, picks the piece of apparel 1070 worn by the RFA 1010 to try fitting.

Step 4, labeled as 240. The shopper sends the body measurement of her target person via internet to the RFA. Refer to the embodiment of the systems of the present invention in FIG. 1, as assumed above, the shopper sends the body measurement from shopper device 1800 to the RVA 1100 and further to the destined RFA 1010 over the remote fitting link.

Step 5, labeled as 250. The RFA adjusts its own body type and size to match the received body measurement under certain constraints, and produces apparel fitting results. The constraints include but are not limited to the manufacturer-set lower and upper limit of body type and size the RFA can adjust to without other constraints, the staff-set lower and upper limit of body type and size the RFA can adjust to when it is clothed in certain piece of apparel, and the lower and upper limit of body type and size the RFA can adjust to when the detected values of body surface pressure are below or within certain range set by the staff or the shopper. If an RFA is unable to match the given body measurement under the constraints, for example, when the received body measurement is too big to fit into the picked piece of apparel 1070, the RFA reports a fitting failure and the details to the shopper. Commonly, the shopper pick a different size of same style and try fitting again.

In another embodiment of the methods of the present invention, the RFA further receives a given skin tone from the shopper. It changes the surface color of its own body (i.e. its own skin tone) to match the given skin tone under certain constraints.

Step 6, labeled as 260. The shopper captures and watches the apparel fitting results via her remote vision provided by the RVA. In an embodiment, the shopper moves the RVA 1100 around the RFA 1010 to check different views of fitting results. In another embodiment, the shopper instructs the RFA 1010 via the remote fitting link to rotate to different angles for her to check the different views of fitting results. In yet another embodiment, the shopper instructs the display base 1030 via the display base link to rotate to different angles for her to check the different views of fitting results. In yet another embodiment, the RFA detects the body surface pressure and reports the pressure data to the shopper in various methods, including but not limited to the shopper's fitting pressure values, the percentage of the shopper's fitting pressure values normalized by the recommended body (i.e. standard body, reference body, or best-fitted body) fitting pressure values, pressure visualized 3D body model, pressure visualized fitting pictures and vision videos, fitting pressure statistics (e.g. the pressure value is in top 10 percent of accumulated fitting trials), and a recommended fitting conclusion.

Step 7, labeled as 270. Add additional fitting results to make a synthesized presentation on the shopper device to enhance the fitting results and experience. This step is optional. In one embodiment, the background music and sound recording is added to the shopper's remote vision. Shoppers trying fitting in different styles of apparel can be given different yet matching music or sound recordings. In another embodiment, a background picture can be added to the video of the shopper's remote vision to simulate the real-world results when the apparel is worn in the target environments. For example, a picture of snow mountain and blue sky is added to replace the background of room 1000 in the video of the shipper's remote vision when the piece of apparel 1070 is a piece of mountain climber's apparel. In yet another embodiment, a background video can be added to the shopper's remote vision video to enhance the fitting results. In yet another embodiment, certain computer-generated external lighting effect is added to the piece of apparel 1070 in the shopper's remote vision to simulate certain real-world results when the apparel is worn in same external lighting, such as spotlight, party light, sun light. In yet another embodiment, certain airflow is added to the piece of apparel 1070 to make waving effect in the shopper's remote vision, either by a reality fan blowing on the piece of apparel 1070 or by computer generated waving effect.

The above methods of the present invention have various variations. In another embodiment of the present invention, the shopper browses the e-commerce web pages to pick the piece of apparel she intends to try fitting. As this is done without the use of an RVA, the order of step 2 and 3 can be switched in this embodiment.

With the assistance of store staff, the above methods of the present invention can be simplified accordingly. These derivative methods are not detailed.

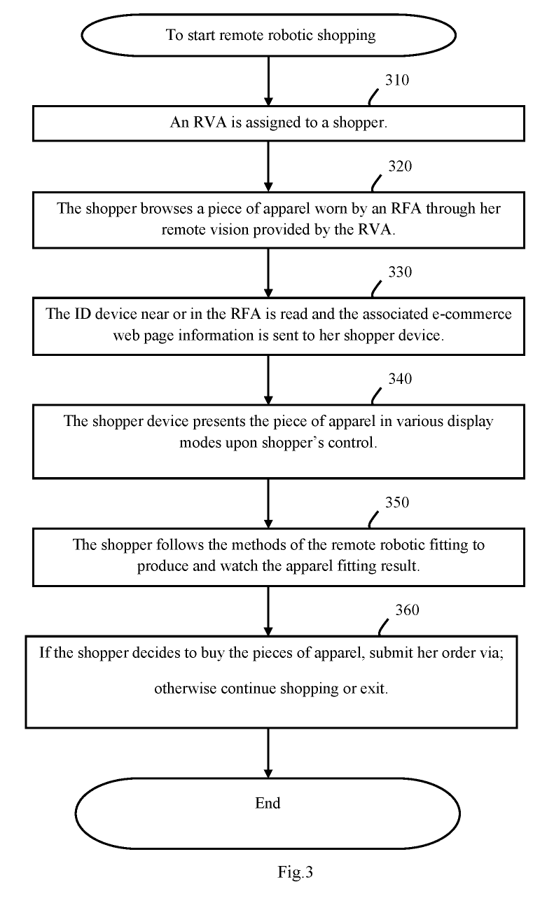

FIG. 3 illustrates an embodiment of the methods of the remote robotic apparel shopping of the present invention, which integrates the remote vision with the associated e-commerce web page information, including the following steps:

Step 1, labeled as 310. An RVA is assigned to a shopper. As assumed above, the shopper is assigned to the RVA 1100.

Step 2, labeled as 320. The shopper browses a piece of apparel worn by an RFA in the room via her remote vision provided by the RVA. As assumed above, the shopper is browsing the piece of apparel 1070 worn by the RFA 1010.

Step 3. labeled as 330. The ID device near or in the RFA to identify the piece of apparel is read and the associated e-commerce webs page information is sent to her shopper device. Referring to the embodiment illustrated in FIG. 1, the visual ID device 1050 is placed on the display base 1030. The shopper controls her RVA 1100 so that the visual ID device 1050 appears legible in her remote vision. In one embodiment, the machine vision subsystem included in the vision link server 1500 analyzes and recognizes the ID information visually displayed on the visual ID device 1050. The ID information is used to locate the associated e-commerce web page information of the piece of apparel 1170. The associated e-commerce web page information or their web addresses are sent to the shopper device 1800.

Step 4, labeled as 340. The shopper device presents the piece of apparel 1070 in various display modes upon shopper's control. The display modes include but are not limited to: parallel display of her remote vision and the associated web page information, overlay display of her remote vision overlaid with the associated web page information, display of her remote vision or display of the associated web page information. In parallel or overlay display of her remote vision and the associated web page information, the shopper simultaneously watches the display of the piece of apparel 1170 visually and reads the associated e-commerce web page information to obtain the text descriptions, photos and videos of the piece of apparel 1170 worn by a human model etc. In an advanced embodiment, with the aid of the machine vision subsystem and the certain positioning subsystem, the vision link server 1500 is able to recognize or detect the details of the piece of apparel 1070, and the information of the details in associated web pages is added into the remote vision to make an augmented reality shopping experience.

Step 5, labeled as 350. The shopper follows the methods of the remote robotic fitting to produce and watch the apparel fitting results.

Step 6, labeled as 360. If the shopper decides to buy the piece of apparel, submit an order, otherwise continue shopping or exit.

The above methods of the remote robotic shopping of the present invention start from personal remote vision provided by the RVA. In another embodiment of the present invention where the remote robotic shopping methods start from e-commerce web pages, in step 1, a shopper browses the existing e-commerce web pages to pick the piece of apparel 1070. After that, in step 2, an RVA is assigned to the shopper. Then the rest steps from step 3 to 6 are followed to conduct the methods of remote robotic apparel shopping. After the shopper picks certain piece of apparel on e-commerce web pages, there are various methods to locate the RFA wearing the piece of apparel. Thus, there are various variations of the remote robotic apparel shopping methods of the present invention to integrate the associated e-commerce service into the methods of the remote robotic shopping. In one embodiment, the RVA 1100 is a mobile RVA, which includes a moving subsystem 1140 and is able to move around from an RFA to another. When the RVA 1100 is available and assigned to the shopper in step 2, her remote vision may not point to the RFA 1010 wearing the piece of apparel 1070 she picked on the web pages. Therefore, it is needed to provide a means for the shopper to locate the RFA 1010 wearing the piece of apparel 1070 to conduct step 3. In one embodiment, a human readable ID information including but not limited to a number is visual displayed on the ID devices 1050 to 1060 and the ID information to locate the piece of apparel 1070 she picks is provided by the e-commerce web pages. Then the shopper drives the RVA 1100 and visually finds the RFA 1010 with matching ID information on the visual ID device 1030. In another embodiment, any visual ID information including the one-dimensional or two-dimensional barcode, the descriptive name of the product, a text string of web page address are visually displayed by the ID devices 1050 to 1060. The web page gives the ID information of the piece of apparel 1070 the shopper picks to the vision link server 1500.

Then the machine vision subsystem in the vision link server 1500 analyzes and recognizes the visual ID information to identity the matching visual ID device 1050 as the shopper visually looks around for the piece of apparel 1070. In yet another embodiment, the ID devices 1050 to 1060 include wireless transmitters that emit a specific radio wave, and the RVA 1100 detects the radio wave and finds the direction to approach the piece of apparel 1070. In yet another embodiment, the RVA 1100 has a local positioning subsystem that allows it to find a given position inside the room 1000. The web pages give the local position information of the piece of apparel 1070 to the RVA 1100, and the RVA 1100 moves to and watch the piece of apparel 1070 autonomously or gives the shopper navigational guidance to move to the piece of apparel 1070.

Similarly, with the assistance of the store staff, the above methods of the present invention can be simplified accordingly. These derivative methods are not detailed.

The present invention is described according to the accompanying drawings and examples. It is to be understood that the present invention is not limited to such embodiments. In the variations of the methods and systems of the present invention, the order of some ones can be changed, some can be combined together, some can be spitted, and some can be modified. Modifications and variations could be effected by those skilled in the art without departing from the spirit or scope of the invention as defined in the appended claims.

### REFERENCE

[1] Patent, CN 202248969U, Self-help situation fitting room

[2] Patent, US 20110106662, system and method for performing online interactive shopping

[3] Patent, US 20120095589A1, System and method for 3d shape measurements and for virtual fitting room internet service

[4] Patent, U.S. Pat. No. 6,546,309B1, Virtual fitting room

I claim:

1. A remote robotic apparel fitting, shopping and showing system, comprising:
(1) one or multiple remote fitting apparatuses;
(2) one or multiple remote vision apparatuses;
(3) network units; and
(4) one or multiple shopper devices at remote end;
wherein the said remote fitting apparatus includes a robotic apparatus, which adjusts its own body type and size according to the received body measurement, fully or partially matches the received body measurement under certain constraints, and produces apparel fitting results,
wherein the said remote vision apparatus captures the apparel fitting results and sends the apparel fitting results to the said shopper devices at remote end via the said network units,
wherein the said network units include internet and local area networks, and are employed for the communications among the said remote fitting apparatuses, the said remote vision apparatuses and the said shopper devices, and
wherein the said shopper devices at remote end are employed to send body measurement and display the said apparel fitting results.

2. The system of claim 1,
wherein the said remote fitting apparatus further includes a body surface pressure measuring apparatus, which measures and collects the values of pressure onto different areas of the surface of the body of the said remote fitting apparatus, and sends the values of pressure to the said shopper devices at remote end.

3. The system of claim 1,
wherein the said remote fitting apparatus further includes a skin tone changing apparatus, which under shopper's control, changes the color of the surface of the body of the said remote fitting apparatus, and matches the skin tone given by the shopper under certain constraints.

4. The system of claim 3,
wherein the said skin tone changing apparatus includes an internal or in-skin color lighting apparatus, which under shopper's control, changes its own color and accordingly changes the color of the surface of the body of the said remote fitting apparatus.

5. The system of claim 1,
wherein the said remote fitting apparatus further includes a rotating apparatus, which under shopper's control, makes the said remote fitting apparatus rotate along one or multiple axes.

6. The system of claim 1, further comprising:
one or multiple display bases, each including a rotating apparatus that makes the said display base rotate among one or multiple axes under shopper's control;
wherein the said remote fitting apparatus is placed on and accordingly rotated by the said display base under shopper's control.

7. The system of claim 1,
wherein the said remote fitting apparatus further includes a pose changing apparatus, which under shopper's control, changes the pose of the said remote fitting apparatus.

8. The system of claim 1,
wherein the said remote vision apparatuses includes mobile remote vision apparatuses, or fixed remote vision apparatuses, or both.

9. The system of claim 8,
wherein the said mobile remote vision apparatus includes: a camera subsystem; a modem subsystem; and a moving subsystem.

10. The system of claim 9,
wherein the said mobile remote vision apparatuses further includes an obstacle detection subsystem, which detects the shortest line-of-sight non-obstructive distance at certain directions or certain ranges of directions.

11. The system of claim 8,
wherein the said fixed remote vision apparatus includes: a camera subsystem; and a modem subsystem.

12. The system of claim 1, further comprising
one or multiple vision link servers;
wherein in the uplink, the said vision link server receives videos of the remote visions from the said remote vision apparatuses, and sends the videos of the remote visions to the said shopper devices at remote end via the said network units, and
wherein in the downlink, the said vision link server receives the control signals from the said shopper devices at remote end, forwards the control signals to the said remote vision apparatuses, the said remote fitting apparatuses and other shopper-controllable apparatuses and devices in the room.

13. The system of claim 12,
wherein the local area networks included in the said network units connect the said remote fitting apparatuses and the said remote vision apparatuses together, and further to the said vision link server, and either internet remotely connects the said vision link server and the said shopper devices at remote end, or the local area networks directly connect the said vision link server and the said shopper devices at remote end.

14. The system of claim 12,
wherein the said vision link server further includes a machine vision subsystem, which analyzes the videos of the remote visions from the said remote vision apparatuses, recognizes certain objects in the videos, and provides additional information about the objects.

15. The system of claim 1,
wherein the said shopper devices include but are not limited to smart phones, tablet computers, notebook computers, desktop computers and wearable computing devices.

16. The system of claim 1, further comprising:
ID devices, which are employed to identify certain objects and provide additional information for apparel;
wherein the said ID devices include visual ID devices; and electronic ID devices.

17. A method for remote robotic apparel fitting, comprising:
(1) a shopper obtaining the body measurement of the target person;
(2) assigning a remote vision apparatus to the shopper;
(3) the shopper controlling the said remote vision apparatus to browse the room and pick certain piece of apparel worn by a remote fitting apparatus to try fitting;
(4) the shopper sending the body measurement of the target person to the said remote fitting apparatus via the network units;
(5) the said remote fitting apparatus adjusting its own body type and size, under certain constraints, matching the received body measurement, and producing apparel fitting results; and
(6) the shopper capturing and watching the apparel fitting results via the remote vision provided by the said remote vision apparatus.

18. The method of claim 17,
wherein the body measurement is obtained by methods including but not limited to manual body measurement and 3-dimensional body scan.

19. The method of claim 17,
wherein the certain constraints include but are not limited to:
the manufacturer-set lower and upper limit of body type and size the RFA can adjust to without other constraints;
the staff-set lower and upper limit of body type and size the RFA can adjust to when it is clothed in certain pieces of apparel; and
and the lower and upper limit of body type and size the RFA can adjust to when the detected values of body surface pressure are below certain values or within certain value ranges that are set by the staff or the shopper.

20. The method of claim 17, further comprising:
the said remote fitting apparatus detecting the values of pressure onto different areas of the surface of the body of the said remote fitting apparatus, and sending the values of pressure to the said shopper device.

21. The method of claim 17, further comprising:
adding the additional fitting results to enhance the fitting results and experience, including:
(1) adding reality additional fitting results that are produced by means of certain reality apparatuses in the room; and
(2) adding virtual additional fitting results that are generated by computers.

22. A method for remote robotic apparel shopping, comprising:
(1) assigning a remote vision apparatus to a shopper through the shopper's shopper device;
(2) the shopper browsing a piece of apparel worn by a remote fitting apparatus in the room via the remote vision provided by the said remote vision apparatus;
(3) the ID device to identify the piece of apparel being read and the associated e-commerce web page information being sent to the said shopper device;
(4) under the shopper's control, the said shopper device presenting the piece of apparel in various display modes;
(5) the shopper adopting the method of remote apparel fitting to produce and watch the apparel fitting results; and
(6) if the shopper decided to buy, submitting a order; otherwise continuing shopping or exiting.

23. The method of claim 22,
wherein the said various display modes include but are not limited to:
parallel display of the shopper's remote vision and the associated web page information;
overlay display of the shopper's remote vision overlaid with the associated web page information;
display of the shopper's remote vision; and
display of the associated web page information.

24. The method of claim 22, before step (1), further comprising:
a shopper browsing the e-commerce web page to pick a piece of apparel to try fitting.
